(19) United States
(12) Patent Application Publication
(10) Pub. No.: US 2006/0042446 A1
(43) Pub. Date: Mar. 2, 2006

(54) Cutting blade

(76) Inventor: Dennis E. See, Peru, IN (US)

Correspondence Address: BARNES & THORNBURG, 11 SOUTH MERIDIAN, INDIANAPOLIS, IN, 46204, US

(21) Appl. No.: 11/213,158

(22) Filed: Aug. 26, 2005

Related U.S. Application Data
(60) Provisional application No. 60/605,571, filed on Aug. 30, 2004.

(51) Int. Cl. B26D 1/12

(52) U.S. Cl. 83/835; 83/663

(57) ABSTRACT

A cutting blade includes a metal base and a polymer coating. The cutting blade is adapted to be mounted in a lawn mower or other cutting apparatus.

This application claims priority under 35 U.S.C. § 119(e) to U.S. Provisional Application Ser. No. 60/605,571, filed Aug. 30, 2004, which is expressly incorporated by reference herein.

### BACKGROUND

The present disclosure relates to a cutting blade, and particularly to a cutting blade for a lawn mower. More particularly, the present disclosure relates to a cutting blade comprising a polymer coating.

Blades are provided on a number of different types of cutting and material handling equipment, such as lawn mowers, shears, hedge trimmers, cycle bar mowers, scissors, clippers, augers, plows, agricultural discs, sod cutters, combines, trenching and ditching equipment, circular saws, rotary saws, and meat cutters/slicers, to name but a few applications. These bladed devices are used to cut grass, small brush, and trees; move dirt, grain, and other materials; and cut hair, wool, and other fibers. Bladed devices are also used for other applications such as impelling materials and propelling boats and aircraft. In all these applications, over time, the blades typically wear and become dull.

### SUMMARY

A cutting blade in accordance with the present disclosure includes a polymer coating bonded to a metal base to establish a leading cutting edge. An underside of the metal base is formed to include polymer-storage cavities containing some of the polymer coating.

In illustrative embodiments, the leading cutting edge comprises a portion of the metal base and a portion of the polymer coating contained in some of the polymer-storage cavities. The leading cutting edge retains such a metal and polymer combination even as the metal base and polymer coating erodes during use of the cutting blade.

Additional features of the present disclosure will become apparent to those of ordinary skill in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a lawn mower, with portions broken away, showing a portion of a newly made treated cutting blade in accordance with the present disclosure mounted to rotate under a deck included in the lawn mower;

FIG. 2 is an enlarged perspective view of the newly made treated cutting blade of FIG. 1 before it was mounted on the lawn mower to assume the rotatable position shown in FIG. 1;

FIG. 3 is a further enlarged perspective view of a right-end portion of the treated cutting blade of FIG. 2, with portions broken away, showing a polymer coating bonded to a downwardly facing surface of a metal base to produce the treated cutting blade;

FIG. 4 is an enlarged perspective view of the underside of a metal base included in the treated cutting blade of FIGS. 1 and 3 after it has been deformed (e.g., by shot peening) to form polymer-storage cavities configured to receive polymer filler therein at a later stage in the blade manufacturing process;

FIG. 5 is a view similar to FIG. 4 after polymer material has been applied to the metal base to fill the polymer-storage cavities and form a polymer bed on the underside of the metal base;

FIG. 6 is an enlarged sectional view taken along line 6-6 of FIG. 2 showing six polymer coating layers cooperating to form a polymer bed on the underside of the metal base and to fill polymer-storage cavities formed in the metal base to produce a newly made treated cutting blade in accordance with the present disclosure;

FIG. 7 is an enlarged sectional view taken along line 7-7 of FIG. 1, with portions broken away, showing sand, gravel, cut grass, and other particulate matter associated with the earth in which grass to be mowed has rooted and “kicked up” inside a blade chamber formed in the lawn mower deck as that high-speed flying particulate matter strikes exposed portions of both the metal base and the polymer bed underlying the metal base as the blade is rotating at high speed to cut grass (some of which is shown);

FIG. 8 is a sectional view similar to FIG. 7 showing the blade after it has been used to cut grass for awhile and exposed to a lot of high-speed flying particulate matter and showing that portions of the metal base and the polymer bed have been eroded by high-speed flying particulate matter inside the blade chamber to produce a leading cutting edge;

FIG. 9 is a greatly enlarged perspective and diagrammatic view of a corner portion of the blade shown in FIG. 8 showing polymer filler retained in the downwardly opening polymer-storage cavities formed in the underside of the metal base and showing that the leading cutting edge of the treated cutting blade comprises both metal base segments and polymer coating segments, which polymer coating segments are formed by exposure of the polymer filler in the polymer-storage cavities of the metal base, as portions of the metal base are worn away, to produce a “self-sharpening” leading cutting edge comprising both metal and polymer materials;

FIG. 10 is a perspective and diagrammatic view of the underside of the corner portion of the blade shown in FIG. 9 showing retention of polymer filler in the downwardly opening polymer-storage cavities formed in the metal base even after the polymer bed outside the polymer-storage cavities has been eroded and worn away and showing that the self-sharpening leading cutting edge comprises both metal and polymer materials;

FIGS. 11-22 show an illustrative evolution of the treated cutting blade in accordance with the present disclosure as the treated cutting blade is used to cut grass and is exposed to high-speed flying particulate matter kicked up during grass mowing activity beginning with a newly made blade shown in FIGS. 11 and 12 and continuing through an illustrative first erosion stage shown in FIGS. 13 and 14, a second erosion stage shown in FIGS. 15 and 16, a third erosion stage shown in FIGS. 17 and 18, a fourth erosion stage shown in FIGS. 19 and 20, and a fifth erosion stage shown in FIGS. 21 and 22;

FIG. 11 is a side elevation view of a portion of a newly made treated cutting blade showing a polymer coating applied to the underside of a metal base;

FIG. 12 is a bottom plan view of a portion of the newly made treated cutting blade of FIG. 11 (at Time T) showing removal of a portion of the polymer bed to reveal polymer filler deposited in each of the polymer-storage cavities formed in the metal base to open in the downwardly facing surface of the metal base;

FIG. 13 is a side elevation view of the treated cutting blade of FIG. 11 at an illustrative first erosion stage (Time T+1) after the blade has been used to cut grass or other material and also showing the profile (in phantom) of the newly made treated cutting blade prior to any erosion;

FIG. 14 is a bottom plan view of a portion of the treated cutting blade of FIG. 13 wherein portions of the metal base and the polymer coating have been eroded to expose polymer filler in some of the polymer-storage cavities at the leading cutting edge and to produce a self-sharpening leading cutting edge comprising a first group of metal base segments and polymer coating segments and showing the boundary of the leading cutting edge of the newly made treated cutting blade in phantom;

FIG. 15 is a side elevation view similar to FIGS. 11 and 13 at an illustrative second erosion stage (Time T+2);

FIG. 16 is a bottom plan view of the portion of the treated cutting blade of FIG. 15 showing a self-sharpening leading cutting edge comprising a second group of metal base segments and polymer coating segments;

FIG. 17 is a side elevation view similar to FIGS. 11, 13, and 15 at an illustrative third erosion stage (Time T+3);

FIG. 18 is a bottom plan view of the portion of the treated cutting blade of FIG. 17 showing a self-sharpening leading cutting edge comprising a third group of metal base segments and polymer coating segments;

FIG. 19 is a side elevation view similar to FIGS. 11, 13, 15, and 17 at an illustrative fourth erosion stage (Time T+4);

FIG. 20 is a bottom plan view of the portion of the treated cutting blade of FIG. 19 showing a self-sharpening leading cutting edge comprising a fourth group of metal base segments and polymer coating segments;

FIG. 21 is a side elevation view similar to FIGS. 11, 13, 15, 17, and 19 at an illustrative fifth erosion stage (Time T+5);

FIG. 22 is a bottom plan view of the portion of the treated cutting blade of FIG. 21 showing a self-sharpening leading cutting edge comprising a fifth group of metal base segments and polymer coating segments;

FIG. 23 is a diagrammatic view of an endoscopic scissors including a blade mechanism comprising first and second treated cutting blades made in accordance with the present disclosure;

FIG. 24 is a side elevation view, with portions broken away, of a first treated endoscopic scissors blade in accordance with another embodiment of the present disclosure and suitable for use in the endoscopic scissors of FIG. 23;

FIG. 25 is view similar to FIG. 24 showing a second treated endoscpic scissors blade in accordance with another embodiment of the present disclosure and suitable for use in the endoscopic scissors of FIG. 23;

FIG. 26 is a perspective view, with portions broken away, of the first and second treated endoscopic scissors blades shown in FIGS. 24 and 25 coupled to one another;

FIG. 27 is a sectional view taken along line 27-27 of FIG. 26 showing the first and second treated endoscopic scissors blades in motion along a shear plane configured to lie between the first and second blades;

FIG. 28 is a perspective view of a reciprocating saw with a treated cutting blade in accordance with the present disclosure; and

FIG. 29 is an enlarged side elevation view, with portions broken away, of the treated cutting blade of FIG. 28 showing portions of treated and untreated surfaces along a serrated edge.

### DETAILED DESCRIPTION

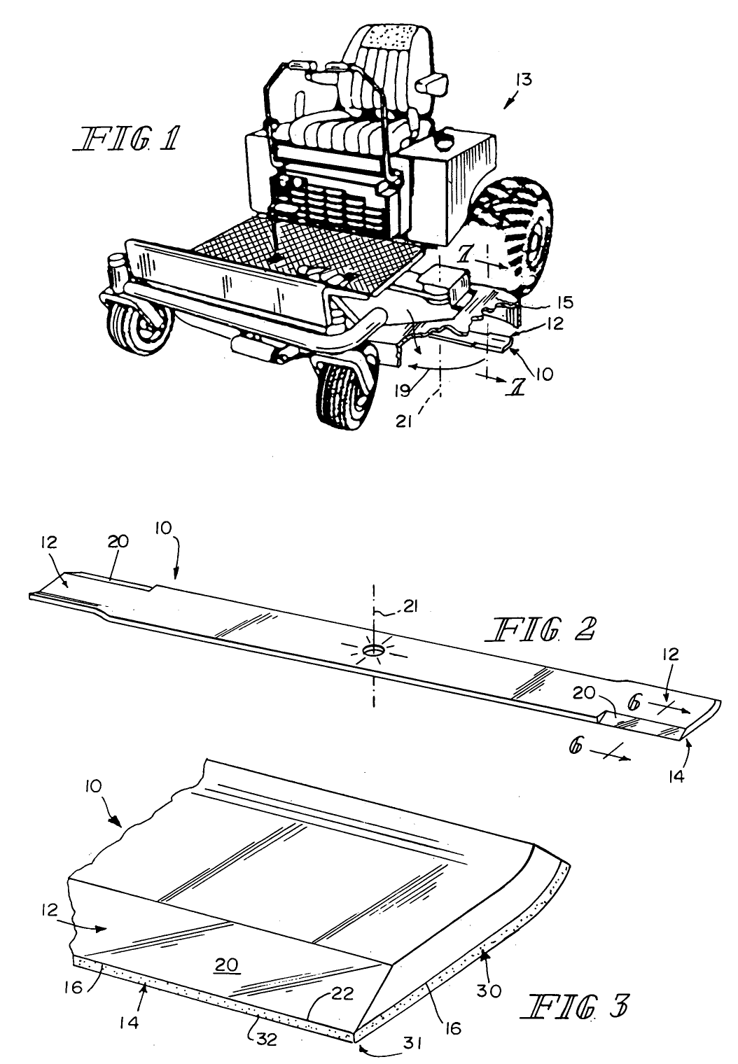

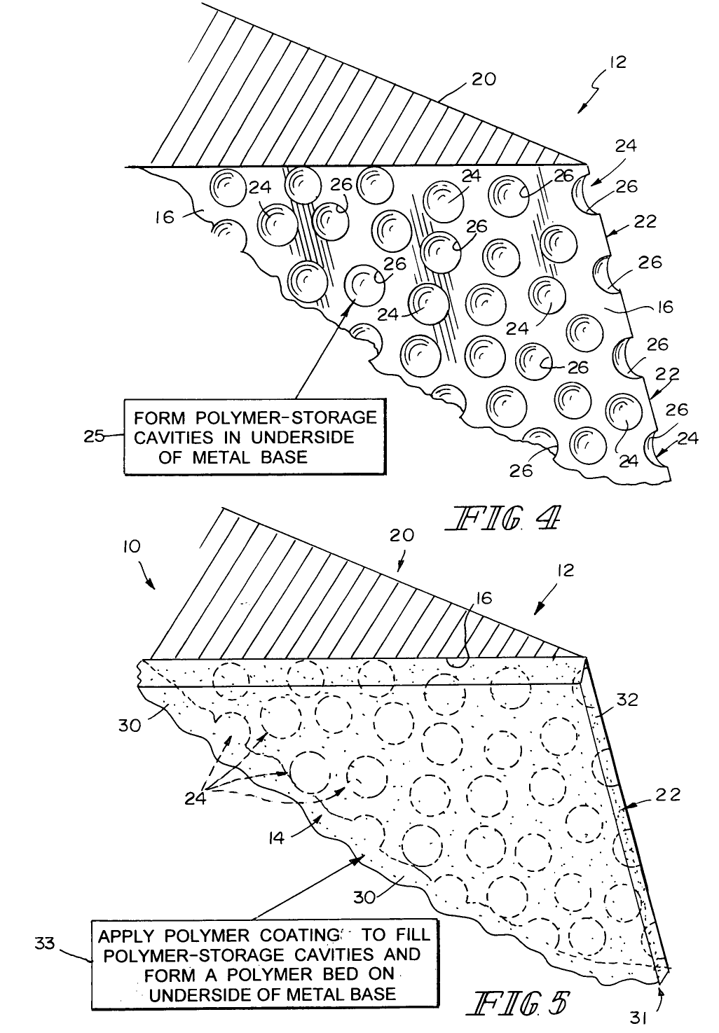

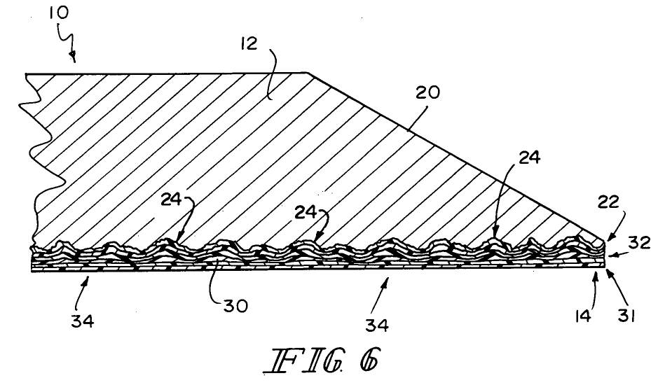

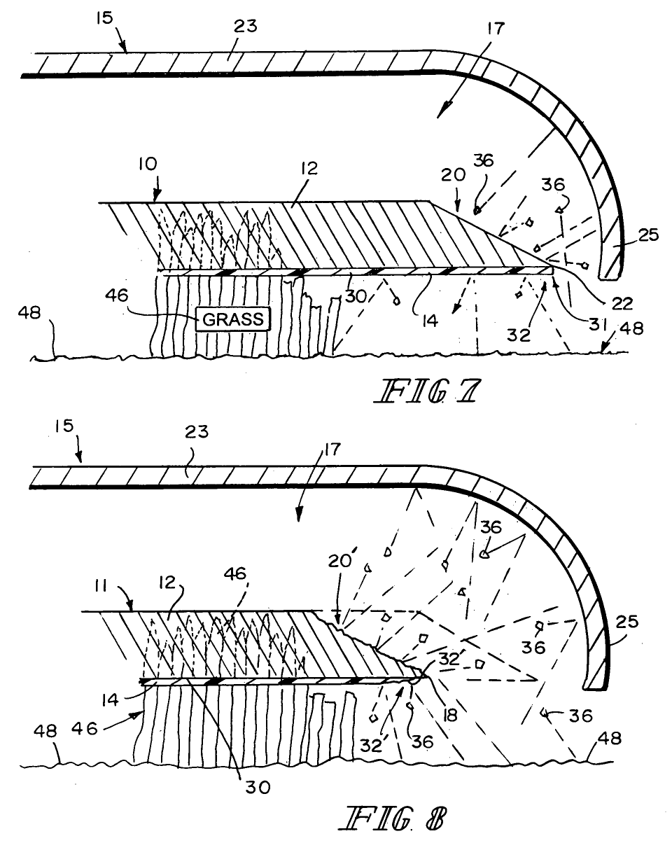

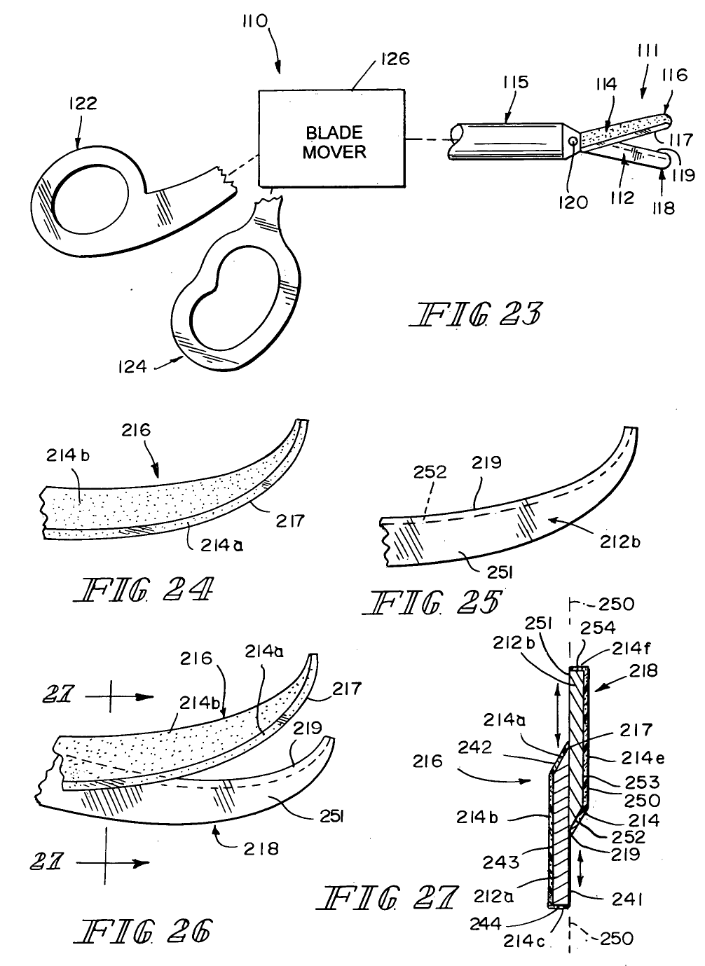

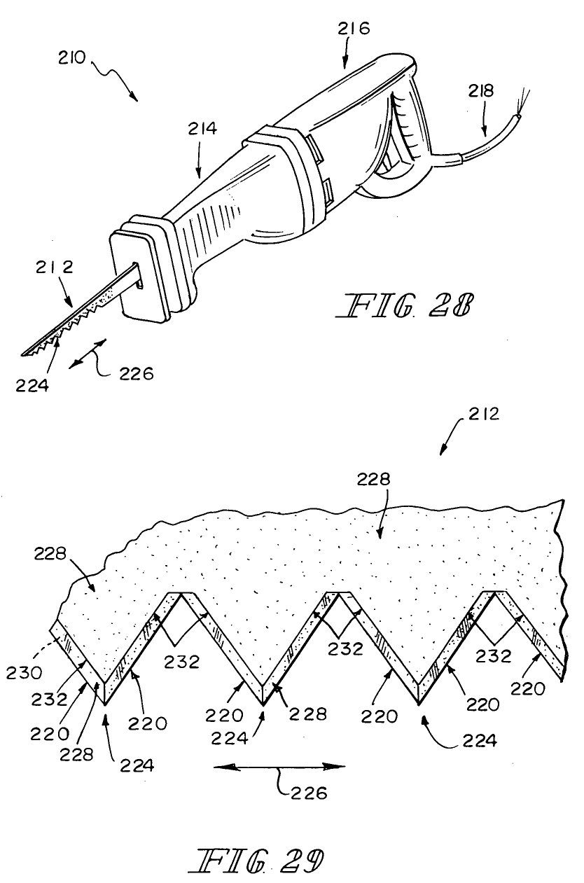

A cutting blade 11 in accordance with the present disclosure includes a leading cutting edge 18 comprising metal segments 42 and polymer segments 44 as suggested in FIGS. 8-10. Leading cutting edge 18 retains such a metal and polymer combination even as cutting blade 11 wears along leading cutting edge 18 during use as suggested, for example, in FIGS. 11-22. An unused and newly made cutting blade 10 in accordance with the present disclosure is shown, for example, in FIGS. 1-3, 6, and 7 and is formed illustratively in a manner shown in FIGS. 4 and 5. Scissors blades in accordance with the present disclosure are shown in FIGS. 23-27 while a reciprocating saw blade in accordance with the present disclosure is shown in FIGS. 28 and 29.

A newly made cutting blade 10 includes a metal base 12 and a polymer coating 14 bonded to metal base 12 as shown, for example, in FIGS. 1-3. Metal base 12 includes a downwardly facing surface 16 and an inclined surface 20 arranged to intersect downwardly facing surface 16 so as to share a common area with downwardly facing surface 16 to define a forward base edge 22 of metal base 12. In illustrative embodiments, metal base 12 is made of, for example, cold roll 1030 or 1040 steel, stainless 400 steel, aluminum, or brass. Polymer coating 14 may be made of, for example, Lumiflon® polyvinylidene difluoride (PVDF) available from Asahi Glass Co., or Dykor® polymer coating available from Whitford Worldwide.

In illustrative embodiments, a newly made blade 10 is produced by forming polymer-storage cavities 24 in the underside of metal base 12 as suggested diagrammatically at 25 in FIG. 4. Next, two or more (e.g., six) polymer coating layers are applied to the underside of metal base 12 to fill polymer-storage cavities 24 with polymer filler 28 and to establish a polymer bed 30 on downwardly facing surface of metal base 12 as shown diagrammatically at 33 in FIG. 5 and illustratively in FIG. 6. Each polymer coating layer has a thickness of about 0.004 inch (0.10 mm) The newly made cutting blade 10 is installed in a cutter such as lawn mower 13 or other suitable tool and readied to cut grass or other material as suggested, for example, in FIG. 1.

A leading cutting edge 18 is established as suggested, for example, in FIGS. 7 and 8 once newly made cutting blade 10 is used to cut grass 46 or other material as newly made cutting blade 10 is transformed to yield cutting blade 11. During this transformation, some of the metal comprising metal base 12 and some of the polymer material comprising polymer filler 28 in polymer-storage cavities 24 and polymer bed 30 erodes as suggested in FIGS. 11-22 to produce a leading cutting edge 18. Even as the size, shape, and location of leading cutting edge 18 evolves owing to metal and polymer erosion, leading cutting edge 18 retains a plurality of metal base segments 42 interspersed among a plurality of polymer filler segments 44 as suggested diagrammatically in FIGS. 9 and 10 and illustratively in FIGS. 14, 16, 18, 20, and 22. The spacing, width, character, and arrangement of metal base segments 42 and polymer filler segments 44 will vary as metal and polymer erosion takes place as suggested in the first (FIGS. 13 and 14), second (FIGS. 15 and 16), third (FIGS. 17 and 18), fourth (FIGS. 19 and 20), and fifth (FIGS. 21 and 22) erosion stages illustrated in the accompanying drawings.

As suggested in FIGS. 9 and 10 (as well as in FIGS. 13-22), a selected “forward-cavity” group 39 of polymer-storage cavities 24 located in blade field 38 contains polymer filler 28 that define the plurality of polymer filler segments 44 included in leading cutting edge 18. The metal base segments 42 are interspersed among those polymer filler segments 44 to define leading cutting edge 18. Polymer filler 28 is also deposited in a “rearward-cavity” group 41 of polymer-storage cavities 24 located outside of blade field 38 and arranged to merge with polymer bed 30.

Illustratively, newly made cutting blade 10 is configured to be used, for example, as a cutting blade for a lawn mower 13 as shown in FIG. 1. Lawn mower 13 includes a cutting deck 15 formed to include a blade chamber 17. Cutting blade 10 is configured to rotate in direction 19 within blade chamber 17 of cutting deck 15 about a vertical cutting blade axis 21. In an illustrative embodiment shown in FIGS. 7 and 8, cutting deck 15 includes a top wall 23 and a round side wall 25 cooperating with top wall 23 to form blade chamber 17.

Referring now to a diagrammatic view provided in FIG. 4, metal base 12 is formed to include a group of polymer-storage cavities 24 associated with downwardly facing surface 16. Polymer-storage cavities 24 may be formed in metal base 12, for example, by “shot peening” downwardly facing surface 16, or by any other surface preparation process suitable to prepare or otherwise deform downwardly facing surface 16 to include cavities for storing a polymer material therein. Each polymer-storage cavity 24 is formed to include an opening 26 in downwardly facing surface 16 so as to interrupt downwardly facing surface 16. As suggested diagrammatically in FIG. 4, some of the polymer-storage cavities 24 formed along forwards base edge 22 of metal base 12 are formed to “interrupt” forward base edge 22. In illustrative embodiments shown in FIGS. 11-22, polymer-storage cavities have non-uniform volumes and are arranged in an unordered manner on downwardly facing surface 16. It is within the scope of this disclosure to allow one or more adjacent polymer-storage cavities 24 to merge with one another.

Polymer coating 14 includes a polymer filler 28 deposited in each polymer-storage cavity 24 and a polymer bed 30 coupled to downwardly facing surface 16 so as to cover downwardly facing surface 16 and polymer filler 28 deposited in each polymer-storage cavity 24 as shown, for example, in FIGS. 2 and 3. Polymer filler 28 is bonded to metal base 12 so as to be retained in each of the polymer-storage cavities 24. In the illustrative embodiment, a plurality of polymer coating layers 34 are applied to metal base 12 in sequence as suggested in FIG. 6. The polymer coating layers 34 cooperate to define polymer filler 28 and polymer bed 30. For example, six separate polymer coating layers 34 are shown in FIG. 6. The initial polymer layer is bonded to metal base 12 and succeeding polymer layers are bonded to an exposed underlying polymer layer.

Polymer bed 30 is arranged to merge with polymer filler 28 at each opening 26 of each polymer-storage cavity 24. As shown, for example, in FIGS. 4 and 5, in a newly made cutting blade 10, polymer bed 30 is configured to terminate at a forward bed surface 32 arranged to lie in a position that is adjacent to (i.e., at or in close proximity to) the forward base edge 22 of metal base 12.

When newly made cutting blade 10 is used to cut grass 46, sand, gravel, grass, and other particulate matter 36 associated with the earth 48 in which grass 46 to be mowed has rooted is disturbed and becomes airborne inside blade chamber 17 and strikes newly made cutting blade 10. The contact between newly made cutting blade 10 and high-speed particulate matter 36 is abrasive and tends to wear away both metal and polymer portions of newly made cutting blade 10. As high-speed particulate matter 36 strikes newly made cutting blade 10, exposed portions of both metal base 12 and polymer bed 30 begin to wear away, as shown, for example, in FIGS. 7 and 8 to produce a cutting blade 11 with a leading cutting edge 18.

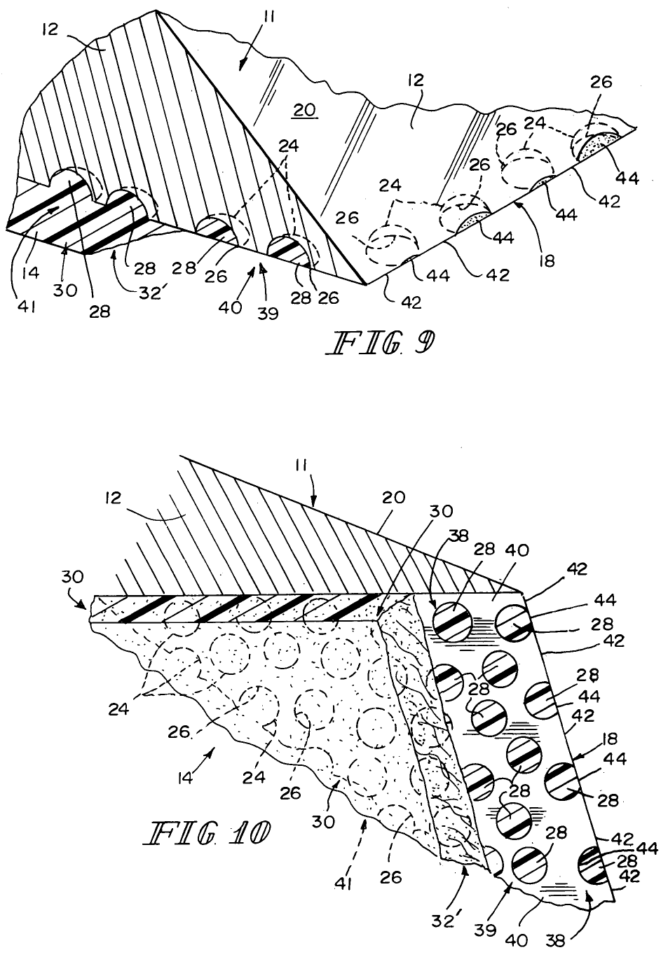

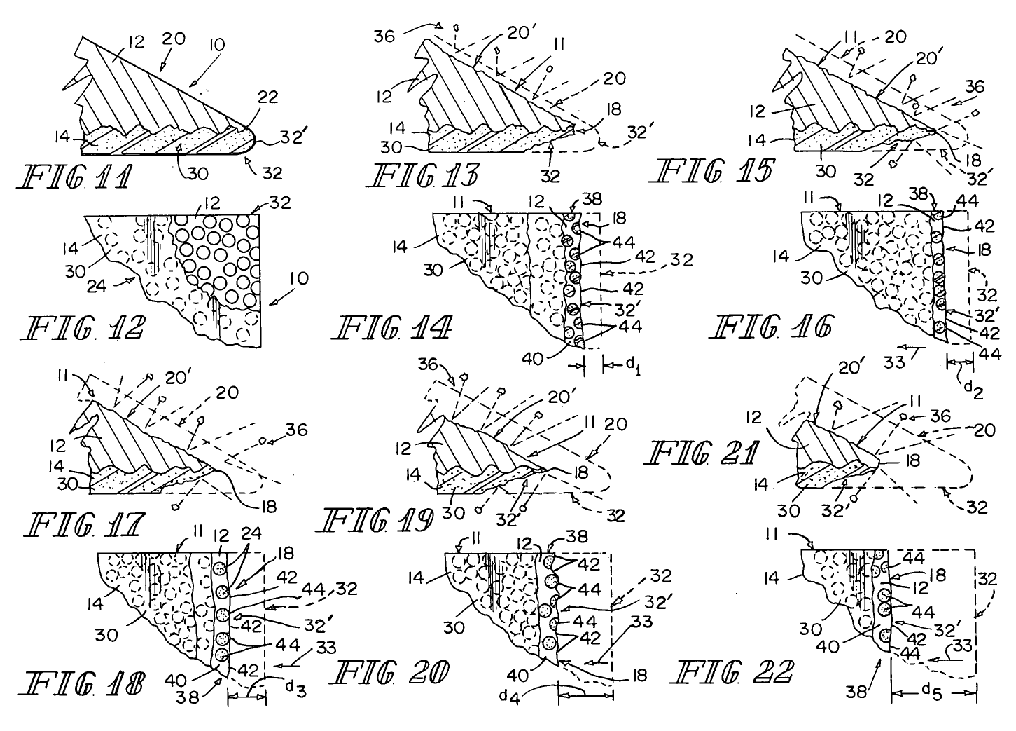

A forward portion 31 of polymer bed 30 is configured to wear away in response to being struck by high-speed flying particulate matter 36 as suggested diagrammatically in FIGS. 9 and 10. As polymer bed 30 wears away, it exposes an eroded forward bed surface 32′ and a blade field 38 that extends laterally along leading cutting edge 18 from leading cutting edge 18 to eroded forward bed surface 32′ of coating bed 30. Blade field 38 comprises an exposed portion 40 of downwardly facing surface 16 and polymer filler 28 deposited in polymer-storage cavities 24 located in exposed portion 40. As polymer bed 30 wears away, eroded forward bed surface 32′ of polymer bed 30 “retreats” in direction 33 so as to increase the erosion distance “d” defined between eroded forward bed surface 32′ and the location of forward bed surface 32 of newly made blade 10 as suggested in FIGS. 12, 14, 16, 18, 20, and 22. For example, with reference to FIGS. 14, 16, 18, 20, and 22, d₅>d₄>d₃>d₂>d₁. Eroded forward bed surface 32′ is arranged to lie in spaced-apart relation to leading cutting edge 18 to locate exposed portion 40 of downwardly facing surface 16 of metal base 12 therebetween.

Metal base segments 42 cooperate with polymer filler segments 44 to define leading cutting edge 18, as suggested diagrammatically in FIGS. 9 and 10. In some illustrative examples, one of the polymer filler segments 44 is arranged to lie between and contact a pair of spaced-apart metal base segments 42. In other examples, one of the metal base segments 42 is arranged to lie between and contact a pair of spaced-apart polymer filler segments 44.

Inclined surface 20 of metal base 12 is also configured to wear away in response to being struck by high-speed flying particulate matter 36 in blade chamber 17 as shown in FIGS. 7 and 8. As inclined surface 20 wears away it exposes an eroded inclined surface 20′. In response to the erosion of inclined surface 20, leading cutting edge 18 is a place where exposed portion 40 of downwardly facing surface 16, polymer filler 28 deposited in polymer-storage cavities 24 located in exposed portion 40, and eroded inclined surface 20′ meet.

Referring now to FIGS. 11-22, as newly made cutting blade 10 is used to cut grass, for example, a continued erosion of eroded inclined surface 20′ and polymer bed 30 acts to maintain generally clearly distinguishable limits, boundaries, or features in the place where exposed portion 40 of downwardly facing surface 16, polymer filler 28 deposited in polymer-storage cavities 24, and eroded inclined surface 20′ meet as metal base 12 and polymer bed 30 progressively wear away. Because metal base 12 is made of material that is softer (i.e., less hard) than the material used to make polymer bed 30, it tends to wear away at a faster rate than polymer bed 30 such that exposed portion 40 of metal base 12, polymer filler 28 deposited in polymer-storage cavities 24, and eroded inclined surface 20′ continue to define leading cutting edge 18. This process acts on cutting blade 11 to cause a “self-sharpening” effect of leading cutting edge 18.

Cutting blades 111 in accordance with another embodiment of the present disclosure are included in endoscopic scissors 110 as suggested, for example, in FIG. 23. One style of scissors blade is shown in FIG. 23, while another style of scissors blade is shown in FIGS. 24-27. In each case, the blades have leading cutting edges comprising metal segments and polymer segments in accordance with the disclosure herein.

As suggested diagrammatically in FIG. 23, endoscopic scissors 110 includes a blade mount 115, first and second cutting blades 116 and 118 mounted on blade mount 115 to pivot relative to one another about a pivot axis 120, and first and second grip handles 122 and 124. A blade mover 126 (shown diagrammatically in FIG. 23) is provided to cause first and second blades 116, 118 to pivot relative to one another to generate a cutting action in response to movement of grip handles 122, 124 toward one another. It is within the scope of this disclosure to configure endoscopic scissors 110 in any suitable manner and to use cutting blades 116, 118 in any scissors.

Each of scissors blades 116, 118 includes a metal base 112 and a polymer coating 114 bonded to metal base 112. Scissors blade 116 includes a leading cutting edge 117 comprising metal and polymer segments. Scissors blade 118 includes a leading cutting edge 119 comprising metal and polymer segments. Each of scissors blades 116, 118 is made in accordance with the disclosure herein.

First and second cutting blades 216, 218 in accordance with yet another embodiment of the present disclosure are shown in FIGS. 24-27 and are suitable for use in endoscopic scissors. First cutting blade 216 includes a leading cutting edge 217 comprising metal and polymer segments and second cutting blade 218 includes a leading cutting edge 219 comprising metal and polymer segments.

As suggested in FIGS. 24 and 27, first cutting blade 216 includes a metal base 212a having an inner surface 241, a leading surface 242, an outer surface 243, and a trailing surface 244. Polymer coating 214a is bonded to leading surface 242 to produce leading cutting edge 217. Polymer coating 214b is bonded to outer surface 243 and polymer coating 214c is bonded to trailing surface 244.

As suggested in FIGS. 25 and 27, second cutting blade 218 includes a metal base 212b having an inner surface 251, a leading surface 252, an outer surface 253, and a trailing surface 254. Polymer coating 214d is bonded to leading surface 252 to produce leading cutting edge 219. Polymer coating 214e is bonded to outer surface 253 and polymer coating 214f is bonded to outer surface 254.

In an illustrative embodiment, stainless 400 steel is used to provide metal bases 212a and 212b and DYKOR® material is used to provide polymer coatings 214a-f. It is within the scope of the present disclosure to use other suitable substrates and coatings.

In the illustrated embodiments, leading surfaces 242, 252 are inclined with respect to reference line 250. It is within the scope of this disclosure to vary such an “incline” angle or to configure leading surfaces 242, 252 to lie in perpendicular relation to reference line 250.

As suggested in FIGS. 26 and 27, first and second cutting blades 216, 218 cooperate to define a cutting instrument, wherein leading cutting edges 217, 219 slide past each other. It is also within the scope of this disclosure to use an endoscopic scissors including cutting blades 216 and 218 as a cauterizing tool during surgery. To that end, an electrical current is applied to cutting blades 216, 218 to generate a voltage so that cutting blades 216, 218 are heated to cauterize tissue during surgery. Polymer coatings 214a-c cooperate to form an electrical insulator on metal base 212a of first cutting blade 216 and polymer coatings 214d-f cooperate to form an electrical insulator on metal base 212b of second cutting blade 218, and these electrical insulators cooperate to prevent unwanted dissipation of energy from cutting blades 216, 218 during surgical cauterizations.

In yet another exemplary embodiment, a reciprocating-type saw 210 includes a treated cutting blade 212 in accordance with the present disclosure, a blade mounting unit, a handle 216, and a power cord 218 as shown, for example, in FIGS. 28 and 29. Cutting blade 212 is configured with opposing sharpened edges 220 for use in a reciprocating-type saw or crosscut blade application. This embodiment of cutting blade 212 includes a number of pointed cutting blades 224 extending perpendicularly with respect to an axis 226 of bidirectional blade travel. Cutting blade 212 includes a polymer coating portion 228 bonded to a metal base portion 230. Sharpened edges 220 are not coated and are arranged to define a base edge 232 between edges 220 and polymer coating portion 228. Cutting blade 212 includes a leading edge 220 comprising metal segments and polymer segments in accordance with the present disclosure. Additional details of reciprocating blade or cycle-bar mowers are shown in U.S. Pat. No. 5,897,972, which patent is hereby incorporated by reference herein.

According to another application, the blade is adapted to operate in a similar manner to the reciprocating-type saw in a shear or scissor configuration, or in a sod cutter configuration wherein the polymer coating is bonded to a surface adjacent to the shear plane. Additional details of scissors and clippers are shown in U.S. Pat. No. 6,604,287, which patent is hereby incorporated by reference herein.

According to yet another embodiment, a cutting blade 10 is configured as a spiral or helical blade for use in an earth auger-type or grain auger-type applications, drill bit-type applications, and for devices such as impellers and propellers. Additional details of augers and drills are shown in U.S. Pat. No. 6,702,046; U.S. Pat. No. 6,681,871; U.S. Pat. No. 6,652,202; U.S. Pat. No. 6,024,520; which patents are hereby incorporated by reference herein.

According to yet another exemplary embodiment, cutting blade 10 is configured as a round disk having sharpened teeth, such as for use in a circular saw-type blade application or rotary saw-type blade application. Additional details of rotary cutters are shown in U.S. Pat. No. 5,996,917; U.S. Pat. No. 4,813,316; and U.S. Pat. No. 4,598,618, which patents are hereby incorporated by reference herein.

1. A cutting blade comprising
a metal base including a downwardly facing surface and an inclined surface arranged to intersect with the downwardly facing surface to define a forward base edge of the metal base, the metal base being formed to include a group of polymer-storage cavities, each of the polymer-storage cavities having an opening in the downwardly facing surface, and
a polymer coating bonded to the metal base, the polymer coating comprising a polymer filler deposited in each of the polymer-storage cavities and a polymer bed coupled to the downwardly facing surface to cover the downwardly facing surface and the polymer filler deposited in the polymer-storage cavities, the polymer bed being configured to terminate at a forward bed surface arranged to lie in a position adjacent to the forward base edge of the metal base.

2. The cutting blade of claim 1, wherein the polymer bed is arranged to merge with the polymer filler at the opening of each polymer-storage cavity formed in the downwardly facing surface of the metal base.

3. The cutting blade of claim 2, wherein a plurality of polymer coating layers are applied to the metal base in sequence and the plurality of polymer coating layers cooperate to define the polymer filler and the polymer bed.

4. The cutting blade of claim 1, wherein the polymer bed is configured to erode in response to being struck by high-speed flying particulate matter to expose a blade field comprising an exposed portion of the downwardly facing surface of the metal base and polymer filler deposited in polymer-storage cavities located in the exposed portion of the downwardly facing surface of the metal blade and to expose a leading cutting edge comprising metal base segments made of metal located in the exposed portion and polymer filler segments made of polymer filler deposited in polymer-storage cavities located in the exposed portion.

5. The cutting blade of claim 4, wherein one of the polymer filler segments is arranged to lie between and contact a pair of spaced-apart metal base segments.

6. The cutting blade of claim 4, wherein one of the metal base segments is arranged to lie between and contact a pair of spaced-apart polymer filler segments.

7. The cutting blade of claim 4, wherein the inclined surface of the metal base is configured to erode in response to begin struck by high-speed flying particulate matter to expose an eroded inclined surface of the metal base and the leading cutting edge is a place where the exposed portion of the downwardly facing surface of the metal base, polymer filler deposited in polymer-storage cavities located in the exposed portion, and the eroded inclined surface of the metal base meet.

8. The cutting blade of claim 4, wherein the polymer bed once eroded includes an eroded forward bed surface arranged to lie in spaced-apart relation to the leading cutting edge to locate the exposed portion of the downwardly facing surface of the metal base therebetween.

9. The cutting blade of claim 1, wherein the polymer-storage cavities are arranged in an unordered manner and have non-uniform volumes.

10. A cutting blade comprising
a metal base including a downwardly facing surface interrupted by openings into polymer-storage cavities formed in the metal base,
a polymer filler deposited in each of the polymer-storage cavities, and
a leading cutting edge comprising a plurality of metal base segments included in the metal base and a plurality of polymer filler segments included in the polymer filler.

11. The cutting blade of claim 10, further comprising a polymer bed coupled to the downwardly facing surface of the metal base and formed to include an eroded forward bed surface arranged to lie in spaced-apart relation to the leading cutting edge to locate an exposed portion of the downwardly facing surface of the metal base therebetween.

12. The cutting blade of claim 11, wherein the exposed portion of the downwardly facing surface is interrupted by exposed portions of polymer filler deposited in polymer-storage cavities located in a blade field provided between the eroded forward bed surface and the leading cutting edge.

13. The cutting blade of claim 12, wherein a selected group of the polymer-storage cavities located in the blade field contain polymer filler that define the plurality of polymer filler segments included in the leading cutting edge.

14. The cutting blade of claim 11, wherein the polymer bed is arranged to merge with the polymer filler at the opening of each polymer-storage cavity formed in the downwardly facing surface of the metal base.

15. The cutting blade of claim 14, wherein a plurality of polymer coating layers are applied to the metal base in sequence and the plurality of polymer coating layers cooperate to define the polymer filler and the polymer bed.

16. The cutting blade of claim 10, wherein one of the polymer filler segments is arranged to lie between and contact a pair of spaced-apart metal base segments.

17. The cutting blade of claim 10, wherein one of the metal base segments is arranged to lie between and contact a pair of spaced-apart polymer filler segments.

18. A cutting blade comprising
a metal base including a downwardly facing surface and an eroded inclined surface arranged to intersect with the downwardly facing surface at a leading cutting edge, the metal base being formed to include polymer-storage cavities having openings interrupting the downwardly facing surface,
a polymer bed bonded to the downwardly facing surface of the metal base and formed to include an eroded forward bed surface arranged to lie in spaced-apart relation to the leading cutting edge to define a blade field therebetween,
a first polymer filler deposited in a rearward-cavity group comprising polymer-storage cavities located outside of the blade field and arranged to merge with the polymer bed, and
a second polymer filler deposited in a forward-cavity group comprising polymer-storage cavities located in the blade field, wherein a portion of the second polymer filler cooperates with portions of the metal base to define the leading cutting edge.

19. The cutting blade of claim 18, wherein a plurality of polymer coating layers are applied to the metal base in sequence and the plurality of polymer coating layers cooperate to define the polymer bed and the first and second polymer fillers.

20. The cutting blade of claim 18, wherein the polymer-storage cavities are arranged in an unordered manner and have non-uniform volumes.
